(19) United States
(12) Patent Application Publication
(10) Pub. No.: US 2022/0113741 A1
(43) Pub. Date: Apr. 14, 2022

(54) SERVER DEVICE, SYSTEM, CONTROL DEVICE, MOVING DEVICE, AND OPERATION METHOD FOR SYSTEM

(71) Applicant: TOYOTA JIDOSHA KABUSHIKI KAISHA, Toyota-shi (JP)

(72) Inventors: Makoto MATSUSHITA, Ichinomiya-shi (JP); Tomo SASAKI, Toyota-shi (JP); Yui NAKAMURA, Nagoya-shi (JP); Satoshi KOMAMINE, Nagoya-shi (JP); Shuichi SAWADA, Nagoya-shi (JP); Tatsuya SUZUKI, Nagoya-shi (JP)

(73) Assignee: TOYOTA JIDOSHA KABUSHIKI KAISHA, Toyota-shi (JP)

(21) Appl. No.: 17/491,693

(22) Filed: Oct. 1, 2021

(30) Foreign Application Priority Data
Oct. 8, 2020 (JP) 2020-170802

(51) Int. Cl. G05D 1/02; H04W 4/024; H04W 4/33; G06Q 10/04

(52) U.S. Cl. CPC G05D 1/0282; H04W 4/024; G06Q 10/047; G05D 1/0214; H04W 4/33

(57) ABSTRACT

The server device includes a communication unit and a control unit that sends and receives information to and from another device via the communication unit. The control unit generates, based on information on a route along which a moving device is to move in a collective facility and information indicating movement of a person in the collective facility, a waiting instruction for causing the moving device to wait at a waiting place near an encounter position where the moving device encounters the person on the route until the person passes the waiting place, and sends the waiting instruction to the moving device.

### CROSS-REFERENCE TO RELATED APPLICATION

This application claims priority to Japanese Patent Application No. 2020-170802 filed on Oct. 8, 2020, incorporated herein by reference in its entirety.

### BACKGROUND

### 1. Technical Field

The present disclosure relates to server devices, systems, control devices, moving devices, and an operation method for the systems.

### 2. Description of Related Art

Techniques for supporting distribution of various goods have been proposed. For example, Japanese Unexamined Patent Application Publication (Translation of PCT Application) No. 2019-531991 (JP 2019-531991 A) discloses a technique for transporting products purchased by mail order to the neighborhood of a dwelling unit of a delivery destination by a transport truck and delivering the products from the transport truck to the delivery destination by an autonomous driving vehicle.

### SUMMARY

Accurate control of operation of moving devices such as autonomous driving vehicles is required.

A server device according to the present disclosure includes a communication unit and a control unit that sends and receives information to and from another device via the communication unit. The control unit generates, based on information on a route along which a moving device is to move in a collective facility and information indicating movement of a person in the collective facility, a waiting instruction for causing the moving device to wait at a waiting place near an encounter position where the moving device encounters the person on the route until the person passes the waiting place, and sends the waiting instruction to the moving device.

A control device according to the present disclosure is mounted on a moving device and includes a communication unit and a control unit that sends and receives information to and from another device via the communication unit. The server device generates, based on information on a route along which the moving device is to move in a collective facility and information indicating movement of a person in the collective facility, a waiting instruction for causing the moving device to wait at a waiting place near an encounter position where the moving device encounters the person on the route until the person passes the waiting place. When the control unit receives the waiting instruction from the server device, the control unit controls the moving device according to the waiting instruction.

An operation method according to the present disclosure is an operation method of a system having a server device and a moving device that perform information communication with each other. The server device generates, based on information on a route along which the moving device is to move in a collective facility and information indicating movement of a person in the collective facility, a waiting instruction for causing the moving device to wait at a waiting place near an encounter position where the moving device encounters the person on the route until the person passes the waiting place, and sends the waiting instruction to the moving device. The moving device operates according to the waiting instruction.

According to the present disclosure, it is possible to accurately control the operation of the moving device.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a configuration example of a delivery support system;

FIG. 2 is a diagram showing a configuration example of a server device;

FIG. 3 is a diagram showing a configuration example of a moving device;

FIG. 4 is a diagram showing a configuration example of sensors in a collective facility;

FIG. 5 is a sequence diagram showing an operation example of the delivery support system;

FIG. 6 is a flowchart showing an operation example of the server device; and

FIG. 7 is a diagram showing an example of a route and a waiting place.

### DETAILED DESCRIPTION OF EMBODIMENTS

Hereinafter, an embodiment will be described.

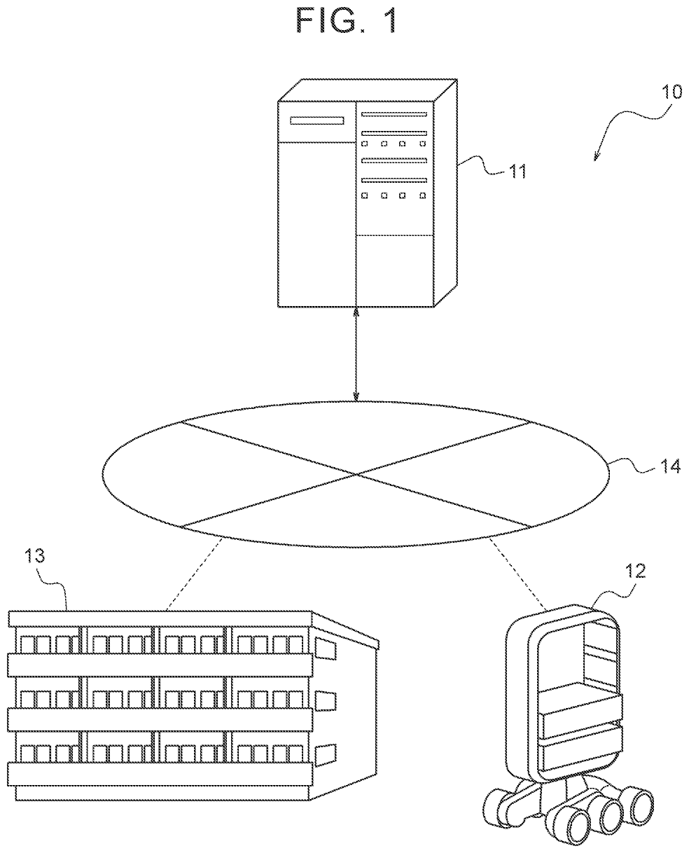

FIG. 1 shows a configuration example of a delivery support system that supports delivery of goods in a present embodiment. In the present embodiment, the goods are delivered to a delivery destination in a collective facility 13. The goods are, for example, products sold and purchased by mail order, foods and beverages to be delivered, and the like. The collective facility 13 includes, for example, a collective housing such as an apartment, and a commercial facility such as an office building. The goods are transported from a distribution base to the neighborhood of the collective facility 13 by a relatively large transport truck or the like, and delivered by a moving device 12 from the transport truck to the dwelling unit or facility of the delivery destination in the collective facility 13 (hereinafter, simply referred to as the delivery destination) under the control of a server device 11.

A delivery support system 10 includes the server device 11 and the moving device 12. The server device 11 and the moving device 12 are connected so as to be able to communicate with each other via a network 14. Further, sensors provided in various places of the collective facility 13 are connected to the network 14, and the server device 11 acquires information indicating various detection results detected by the sensors via the network 14. The server device 11 is, for example, a server belonging to a cloud computing system or other computing systems, and a server implemented with various functions. The moving device 12 is a relatively small vehicle, a walking machine, or the like that can move along passages in the collective facility 13. The moving device 12 has, for example, dimensions and a shape that fit in a rectangular parallelepiped space having a side of several tens to one hundred and several tens of centimeters. The moving device 12 includes, for example, a moving mechanism for driving wheels or walking legs by electric power of a battery, and a stand on which goods can be loaded. The network 14 is, for example, the Internet, but includes an ad hoc network, a local area network (LAN), a metropolitan area network (MAN), another network, or a combination thereof.

In the delivery support system 10, when the moving device 12 loads the goods and moves along the passages in the collective facility 13 from the transport truck to the delivery destination, the server device 11 generates, based on information on a route along which the moving device 12 is to move and movement information indicating movement of a person in the collective facility 13, an instruction for causing the moving device 12 to wait (hereinafter referred to as a waiting instruction) at a waiting place near an encounter position where the moving device 12 encounters the person on the route until the person passes the waiting place, and sends the waiting instruction to the moving device 12. The person is a resident or an employee in the collective facility 13. The waiting place is a space where the moving device 12 evacuates and can avoid interference with the person, such as a hall provided adjacent to the passages, a landing, other surplus spaces, surplus spaces at a corner of a turn, and a place where the width of the passage is partially expanded. With operation of the delivery support system 10 as described above, even though the passages in the collective facility 13 are narrow, by instructing the moving device 12 to wait at the waiting place, it is possible for the moving device 12 to avoid interference with the person at the encounter position in the passages, and reduce the possibility that the moving device 12 obstructs the passages of the person or injures the person. Therefore, the operation of the moving device 12 can be accurately controlled. As a result, it becomes possible to contribute to the improvement of safety in the collective facility 13.

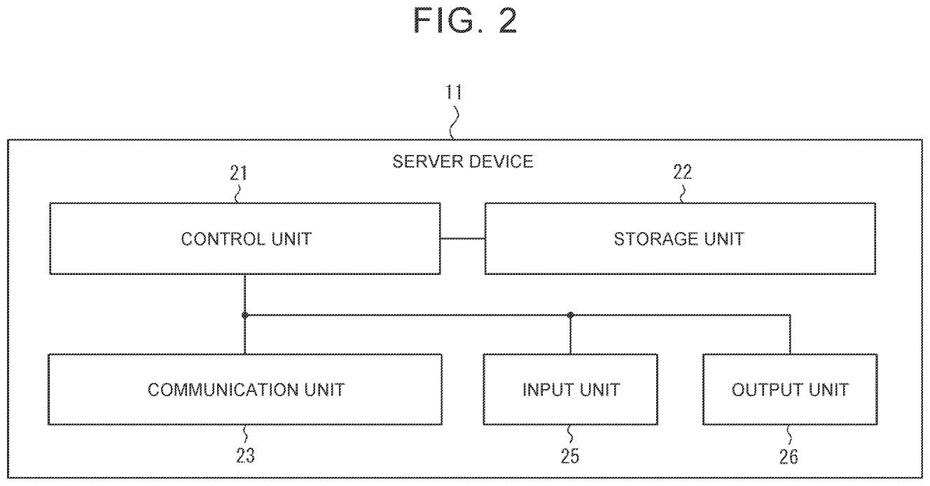

FIG. 2 shows a configuration example of the server device 11. The server device 11 includes a control unit 21, a storage unit 22, a communication unit 23, an input unit 25, and an output unit 26. The server device 11 is, for example, a server computer belonging to a cloud computing system or other computing systems, and a server computer functioning as a server implemented with various functions. The server device 11 may be one or more server computers that are connected to each other so as to be able to communicate with each other and operate in cooperation with each other.

The control unit 21 includes one or more processors, one or more dedicated circuits, or a combination thereof. The processor is a general-purpose processor such as a central processing unit (CPU) or a dedicated processor specialized for a specific process such as a graphics processing unit (GPU). The dedicated circuit is, for example, a field-programmable gate array (FPGA) or an application-specific integrated circuit (ASIC). The control unit 21 executes information processing related to the operation of the server device 11 while controlling each unit of the server device 11.

The storage unit 22 includes, for example, one or more semiconductor memories, one or more magnetic memories, one or more optical memories, or a combination of at least two of them, functioning as a main storage device, an auxiliary storage device, or a cache memory. The semiconductor memory is, for example, a random access memory (RAM) or a read-only memory (ROM). The RAM is, for example, a static random access memory (SRAM) or a dynamic random access memory (DRAM). The ROM is, for example, an electrically erasable programmable read only memory (EEPROM). The storage unit 22 stores the information used for the operation of the server device 11 and the information obtained through the operation of the server device 11.

The communication unit 23 includes one or more communication interfaces. The communication interface is, for example, a LAN interface. The communication unit 23 receives information used for the operation of the server device 11, and transmits information obtained through the operation of the server device 11. The server device 11 is connected to the network 14 via the communication unit 23, and performs information communication with other devices via the network 14.

The input unit 25 includes one or more input interfaces. The input interface is, for example, a physical key, a capacitive key, a pointing device, a touch screen integrated with a display, or a microphone that receives voice input. The input interface may further include a camera that captures images or image codes, or an integral circuit (IC) card reader. The input unit 25 receives operation for inputting the information used for the operation of the server device 11, and transmits the input information to the control unit 21.

The output unit 26 includes one or more output interfaces. The output interface is, for example, a display or a speaker. The display is, for example, a liquid crystal display (LCD) or an organic electro-luminescence (EL) display. The output unit 26 outputs the information obtained through the operation of the server device 11.

The function of the server device 11 is realized by executing a control program using the processor included in the control unit 21. The control program is a program for causing a computer to execute a process of a step included in the operation of the server device 11 such that the computer can realize a function corresponding to the process of the step. That is, the control program is a program for causing the computer to function as the server device 11. A part or all of the functions of the server device 11 may be realized by a dedicated circuit included in the control unit 21.

In the present embodiment, the storage unit 22 stores information indicating the shape, dimensions, arrangement, etc. of the passages in the collective facility 13 (hereinafter referred to as layout information). When the moving device 12 delivers the goods, the control unit 21 derives a route along which the moving device 12 is to move using the layout information of the collective facility 13 where the delivery destination is located, and generates an instruction for causing the moving device 12 to move along the route (hereinafter referred to as a movement instruction) and the waiting instruction.

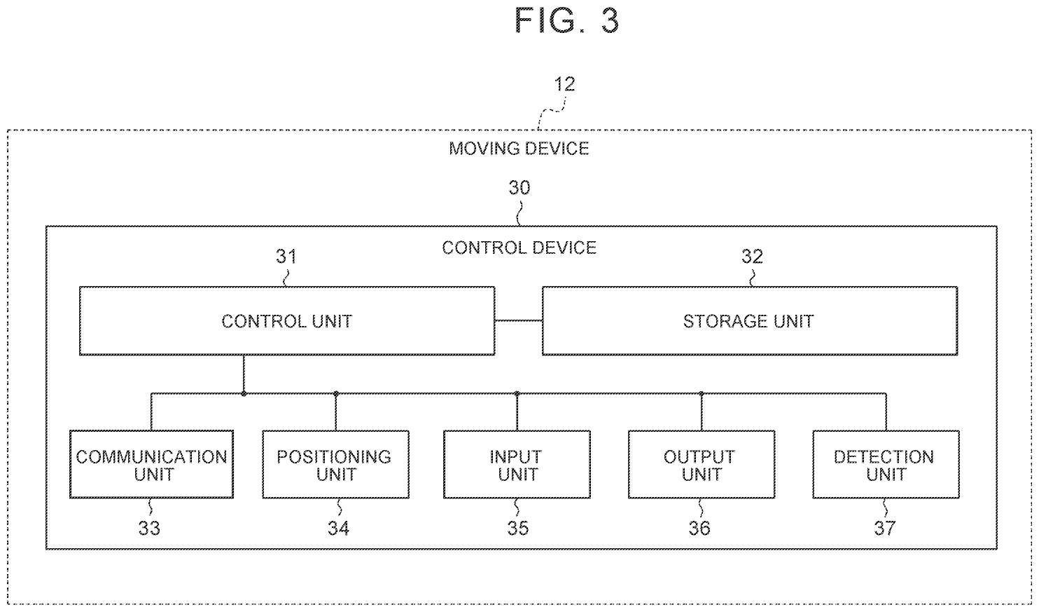

FIG. 3 is a configuration example of a control device 30 mounted on the moving device 12. When the moving device 12 loads the goods and moves from the transport truck to the delivery destination, the control device 30 comprehensively controls the operation of the moving device 12 while performing information communication with the server device 11. The control device 30 includes a control unit 31, a storage unit 32, a communication unit 33, a positioning unit 34, an input unit 35, an output unit 36, and a detection unit 37.

The control unit 31 includes one or more processors, one or more dedicated circuits, or a combination thereof. The processor is a general-purpose processor such as a CPU, or a dedicated processor specialized for a specific process. The dedicated circuit is, for example, an FPGA or an ASIC. The control unit 31 executes information processing related to the operation of the control device 30 while controlling each unit of the control device 30.

The storage unit 32 includes, for example, one or more semiconductor memories, one or more magnetic memories, one or more optical memories, or a combination of at least two of them, functioning as a main storage device, an auxiliary storage device, or a cache memory. The semiconductor memory is, for example, a RAM or a ROM. The RAM is, for example, a SRAM or a DRAM. The ROM is, for example, an EEPROM. The storage unit 32 executes information processing related to the operation of the control device 30, and stores information used for the operation of the control device 30 and information obtained by the operation of the control device 30.

The communication unit 33 includes one or more communication interfaces. The communication interface is, for example, an interface compatible with mobile communication standards such as a long term evolution (LTE), 4G, or 5G. The communication unit 33 receives information used for the operation of the control device 30, and transmits information obtained through the operation of the control device 30. The control device 30 is connected to the network 14 through the communication unit 33 via a mobile communication base station, and performs information communication with other devices via the network 14.

The positioning unit 34 includes one or more Global Navigation Satellite System (GNSS) receivers. The GNSS includes, for example, at least one of Global Positioning System (GPS), Quasi-Zenith Satellite System (QZSS), BeiDou, Global Navigation Satellite System (GLONASS), and Galileo. The positioning unit 34 acquires the position information of the moving device 12.

The input unit 35 includes one or more input interfaces. The input interface is, for example, a camera that captures images, a physical key, a capacitive key, a pointing device, a touch screen integrated with a display, or a microphone that receives voice input. The input interface may further or include an IC card reader. The input unit 35 receives operation for inputting the information used for the operation of the control device 30, and transmits the input information to the control unit 31.

The output unit 36 includes one or more output interfaces. The output interface is, for example, a display or a speaker. The display is, for example, a LCD or an organic EL display. The output unit 36 outputs the information obtained through the operation of the control device 30.

The detection unit 37 has sensors that detect the state of the environment around the moving device 12. The state of the environment around the moving device 12 is the distance to the wall surface of the passage, the presence or absence of an object such as an obstacle, the distance to the object, and the like. The sensors include an image sensor, a temperature sensor, a voice sensor, a distance sensor and the like. The detection unit 37 sends the detection result of the sensors to the control unit 31.

The function of the control device 30 is realized by executing a control program using the processor included in the control unit 31. The control program is a program for causing a computer to execute a process of a step included in the operation of the control device 30 such that the computer can realize a function corresponding to the process of the step. That is, the control program is a program for causing the computer to function as the control device 30. A part or all of the functions of the control device 30 may be realized by a dedicated circuit included in the control unit 31.

In the present embodiment, the control device 30 controls movement of the moving device 12 such that the moving device 12 moves along the passages in the collective facility 13 based on the route according to the movement instruction from the server device 11 and waits at the waiting place according to the waiting instruction. The control device 30 derives control information such as a movement direction, a movement amount, and a movement speed of the moving device 12 based on the current position of the moving device 12 and the state of the environment around the moving device 12, and controls the movement mechanism using the control information, so that the moving device 12 moves along the route toward the delivery destination or the waiting place.

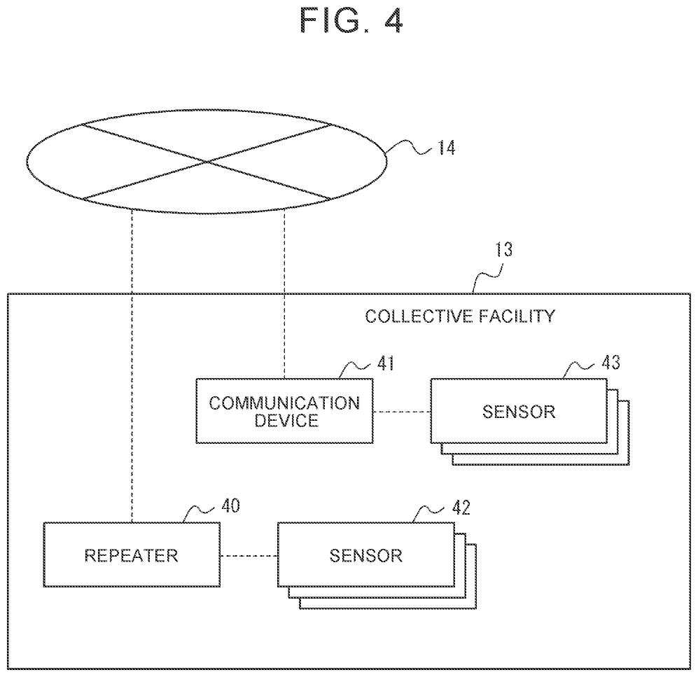

FIG. 4 is a diagram showing an example of the sensors provided in the collective facility 13. Sensors 42 and 43 are provided in various places in the collective facility 13. The sensor 42 has a wired or wireless communication module connected to a repeater 40 such as a gateway provided at a desired position in the collective facility 13, and is connected to the network 14 via the repeater 40. The sensor 42 sends the detection result to the server device 11 via the network 14. The sensor 42 is, for example, an image sensor, a voice sensor, a temperature sensor, or the like provided in a room or a passage. Further, the sensor 42 includes, for example, a sensor for detecting the operating state of electrical equipment such as lighting and air conditioning in the room, a sensor incorporated in various home appliances for detecting the operating state of the home appliances, a sensor for detecting the opening/closing states of windows, curtains, doors, etc. in the room, and the like. The sensor 43 has a wired or wireless communication module connected to a communication device 41 such as a smartphone equipped with a mobile communication module, and is connected to the network 14 via the communication device 41. The sensor 43 sends the detection result to the server device 11 via the network 14. The sensor 43 is, for example, a position sensor, an acceleration sensor, or the like included in a device such as a wearable device that is connected to the communication device 41 by short-range wireless communication and is worn by a person. Alternatively, the sensor 43 may be a position sensor, an acceleration sensor, or the like integrally configured with the communication device 41.

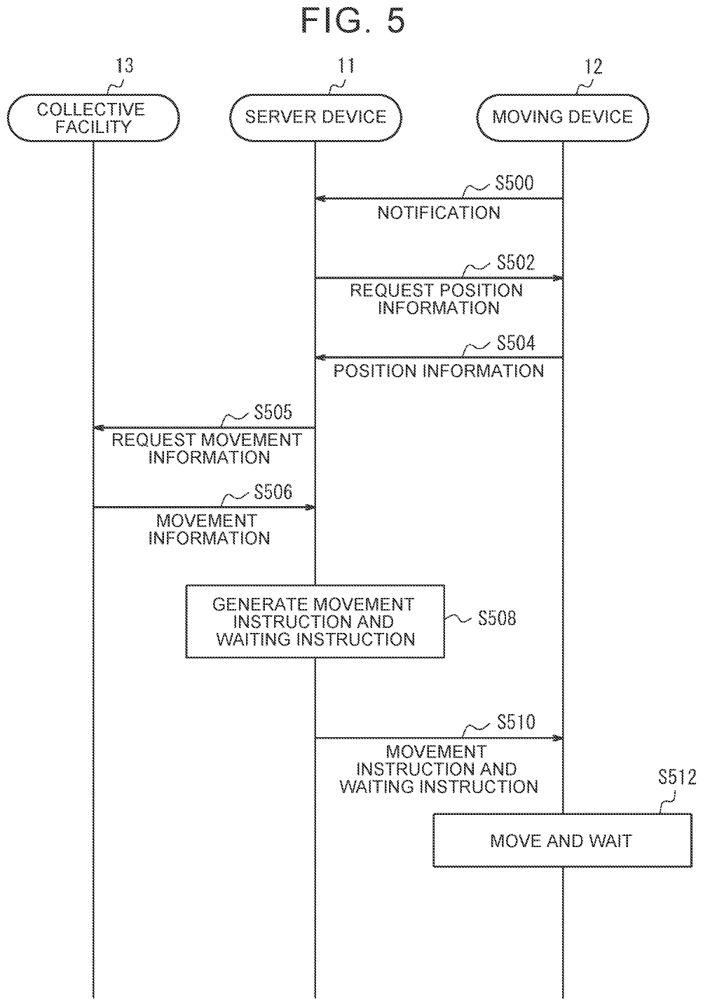

FIG. 5 is a sequence diagram showing an operation procedure of the delivery support system 10. FIG. 5 shows a procedure for linking the sensors of the server device 11, the moving device 12, and the collective facility 13. Prior to the procedure of FIG. 5, the server device 11 has acquired the delivery destination information. The server device 11 may acquire the delivery destination information of the goods from the server of the seller such as mail order and delivery, or the server device 11 may also serve as a server of the seller to acquire the delivery destination information. When a transport truck or the like that transports the goods arrives in the neighborhood of the collective facility 13 including the delivery destination, for example, a location within a few meters to several tens of meters from the common entrance of the collective facility 13, the goods to be delivered are loaded on the moving device 12 manually by a worker or by an automatic machine. The moving device 12 may be transported together with the goods by the transport truck, or may be deployed in the collective facility 13. When loading of the goods on the moving device 12 is completed, for example, the worker inputs information indicating the completion of loading to the control device 30, or the control device 30 receives information indicating the completion of loading from the automatic machine or the like by communication.

In step S500, the moving device 12 sends, to the server device 11, a notification indicating the completion of loading of the goods. In the moving device 12, the control unit 31 of the control device 30 sends, to the server device 11, the notification indicating the completion of loading of the goods by the communication unit 33. In the server device 11, the control unit 21 receives the notification via the communication unit 23.

In step S502, the server device 11 requests position information to the moving device 12. In the server device 11, the control unit 21 sends a request for the position information to the moving device 12 via the communication unit 23. In the moving device 12, the control unit 31 of the control device 30 receives the request for the position information through the communication unit 33. In response to this request, the control unit 31 acquires the position information of the current position from the positioning unit 34 in step S504, and sends the position information to the server device 11 through the communication unit 33. In the server device 11, the control unit 21 receives the position information via the communication unit 23.

In step S505, the server device 11 requests movement information to the sensors 42 and 43 of the collective facility 13. In the server device 11, the control unit 21 sends a request for the movement information to the collective facility 13 via the communication unit 23. The movement information is information indicating the movement of a person in the collective facility 13, and includes various detection results by the sensor 42 or 43. The detection results include, for example, a captured image of a room or a passage including a person, a sound or a temperature indicating the presence of the person in the room or the passage, an operating state of electrical equipment or home appliances in the room, opening/closing states of windows, curtains, or doors of the room, and the position or the movement speed of a device worn or carried by the person. At the collective facility 13, the sensors 42 and 43 receive requests for movement information via the repeater 40 and the communication device 41, respectively. In response to this request, in step S506, the sensor 42 or 43 sends the movement information to the server device 11 via the repeater 40 or the communication device 41, respectively. In the server device 11, the control unit 21 receives the position information via the communication unit 23.

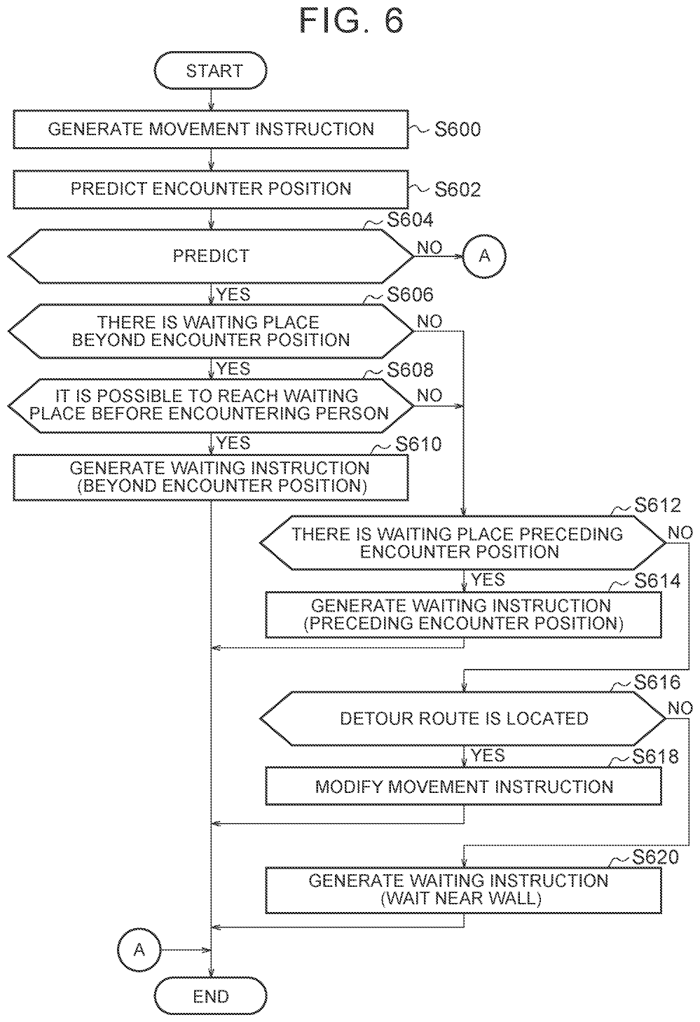

In step S508, the server device 11 generates, based on the movement information, a movement instruction and a waiting instruction to be sent to the moving device 12. Details of the procedure in step S508 will be described later with reference to FIG. 6.

In step S510, the server device 11 sends the movement instruction and the waiting instruction to the moving device 12. The control unit 21 of the server device 11 sends each instruction to the moving device 12 via the communication unit 23. In the moving device 12, the control unit 31 of the control device 30 receives each instruction via the communication unit 33.

In step S512, the moving device 12 moves along the route instructed by the movement instruction, and waits for the instructed waiting time at the waiting place instructed by the waiting instruction. The control unit 31 of the control device 30 drives the movement mechanism in the movement direction, the movement amount, the movement speed, and the like based on the movement instruction to cause the moving device 12 to move. When the control unit 31 determines that the moving device 12 has reached the waiting place based on the position information acquired from the positioning unit 34, the control unit 31 controls the operation of the moving device 12 by driving the movement mechanism in the movement direction, the movement amount, the movement speed, and the like that cause the moving device 12 to evacuate at the waiting place to stop. The control unit 31 measures time since the moving device 12 is caused to evacuate at the waiting place, and when the waiting time elapses, the control unit 31 drives the movement mechanism in the movement direction, the movement amount, the movement speed, and the like based on the movement instruction to restart the movement of the moving device 12. Then, the moving device 12 completes the movement to the delivery destination.

Steps S502 to S512 are performed at a desired cycle (for example, a cycle of several seconds). When steps S502 to S512 are performed periodically, the server device 11 updates the predicted encounter position and the selected waiting place in step S508 each time according to the positions of the moving device 12 and the person that keep changing. In step S510, the movement instruction and the waiting instruction are sent to the moving device 12. The moving device 12 may autonomously determine the timing at which the moving device 12 waits at the waiting place and its waiting time, or the server device 11 may instruct, to the moving device 12, the timing at which the moving device 12 waits and the timing at which the waiting time elapses based on the positions of the moving device 12 and the person.

FIG. 6 is a flowchart showing an example of an operation procedure by the control unit 21 of the server device 11.

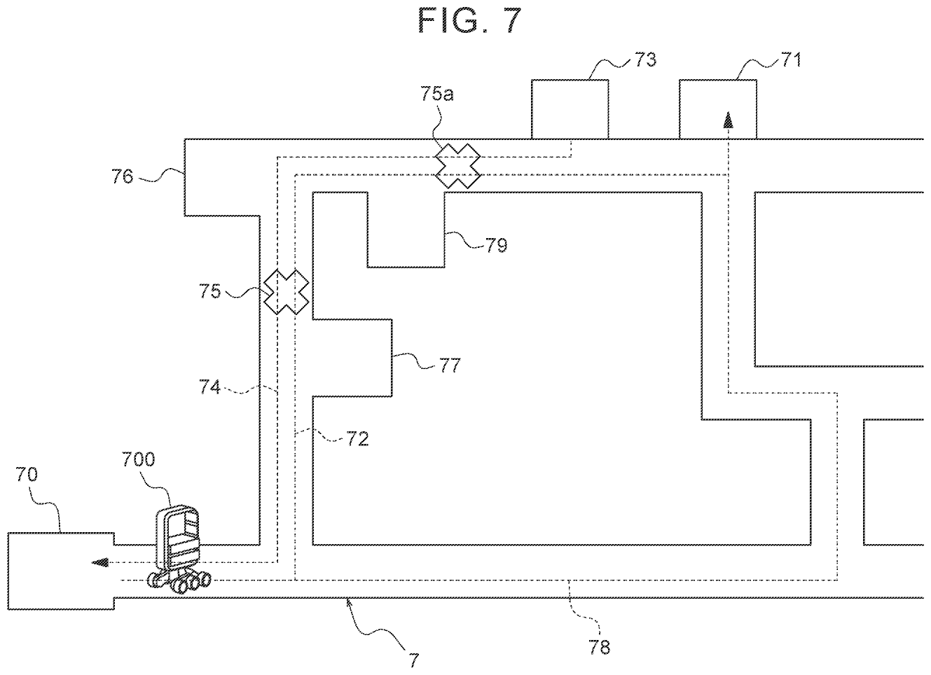

In step S600, the control unit 21 derives a route along which the moving device 12 is to move in the passages in the collective facility 13 based on the position information of the moving device 12, the delivery destination information, and the layout information. Then, the control unit 21 generates the movement instruction for causing the moving device 12 to move along the route. When the moving device 12 can move along a plurality of routes, a route with the shortest required time is selected. Here, reference is made to FIG. 7 that shows an example of the layout in the collective facility 13. FIG. 7 shows a common entrance 70, a delivery destination 71, and a room 73 that are connected by a passage 7. Here, a current position 700 of the moving device 12 is located near the common entrance 70. The control unit 21 derives a route 72 toward the delivery destination 71 from the current position 700 of the moving device 12, and generates the movement instruction for instructing the moving device 12 to move along the route 72.

In step S602, the control unit 21 predicts an encounter position where the moving device 12 and the person encounter with each other. For example, the control unit 21 predicts a route along which the person moves on a passage based on the movement information. For example, the control unit 21 derives the position of the person based on the captured image of the room or the passage including the person, the sound or temperature indicating the presence of the person, the position information of the device worn or carried by the person, and the like. Based on the change with time, the control unit 21 derives the movement direction and the movement speed of the person moving along the passage from the room. The control unit 21 may derive the movement speed of the person based on acceleration of the device worn or carried by the person. When the common entrance is located ahead of the movement direction, it is highly probable that the person heads for the common entrance, so that the control unit 21 predicts a route along which the person heads for the common entrance from the room. When the person can move along a plurality of routes, the control unit selects a route with the shortest required time. For example, as shown in FIG. 7, a route 74 along which the person heads for the common entrance 70 from the room 73 is predicted. Then, the control unit 21 derives the movement speed of the moving device 12 from the chronological change of the position of the moving device 12, and predicts the encounter position where the moving device 12 encounters the person based on the route, the position, and the movement speed of the moving device 12, and the route, the position, and the movement speed of the person. The control unit 21 may predict the encounter position using a standard movement speed of the moving device 12. The standard movement speed is determined as appropriate in advance. Alternatively, the control unit 21 may acquire the position information and information on the movement speed from the control device 30 of the moving device 12. As shown in FIG. 7, since the route 72 along which the moving device 12 moves and the route 74 along which the person moves overlap, the control unit 21 predicts the position where the moving device 12 and the person encounter with each other on the way while the moving device 12 and the person are moving along the route 72 and the route 74, respectively, that is, an encounter position 75.

When the control unit 21 predicts the encounter position (Yes in step S604), the routine proceeds to step S606. When the control unit 21 does not predict the encounter position (No in step S604), for example, the movement of the person that is expected to encounter the moving device 12 is not detected, or the route along which the person moves is different, the control unit 21 does not generate a waiting instruction, and ends the procedure in FIG. 6. In this case, in step S510 of FIG. 5, the waiting instruction from the server device 11 to the moving device 12 is omitted. Then, in step S512, the moving device 12 moves to the delivery destination without waiting on the way.

In step S606, the control unit 21 determines whether the waiting place is located beyond the encounter position, that is, closer to the delivery destination than the encounter position is. The control unit 21 searches for the waiting place based on the layout information. When such a waiting place is located (Yes in step S606), the control unit 21 proceeds to step S608.

In step S608, the control unit 21 determines whether the moving device 12 can reach the waiting place located beyond the encounter position by accelerating before encountering the person. The control unit 21 makes a determination using a speed increased from the current movement speed within a range of the movement speed of the moving device 12 determined as appropriate in advance. The range of the movement speed of the moving device 12 is, for example, approx. 2 km/h (normal time) to approx. 4 km/h (maximum). When the moving device 12 can reach the waiting place (Yes in step S608), the control unit 21 proceeds to step S610.

In step S610, the control unit 21 generates a waiting instruction for causing the moving device 12 to move to the waiting place located beyond the encounter position and wait. Based on the layout information, the control unit 21 generates the waiting instruction including information on the position of the waiting place located beyond the initial encounter position and information on the movement speed required for the moving device 12 to reach the waiting place before encountering the person. For example, as shown in FIG. 7, in a case where a waiting place 76 is located beyond the encounter position 75 along the route 72 of the moving device 12 and the moving device 12 can reach the waiting place 76 before encountering the person if the moving device 12 accelerates, the control unit 21 generates the waiting instruction for causing the moving device 12 to accelerate, move to the waiting place 76, and wait at the waiting place 76. Note that when there is a plurality of such waiting places, the control unit 21 selects a waiting place closest to the delivery destination 71 to generate the waiting instruction. Thereby, the time for which the moving device 12 waits at the waiting place until the person passes the waiting place can be minimized, and eventually the moving device 12 can reach the delivery destination 71 in the shortest required time. Further, the control unit 21 derives the waiting time for which the moving device 12 is to wait at the waiting place 76 until the person passes the waiting place 76 based on the movement speed of the person, and includes information on the waiting time in the waiting instruction.

When there is no waiting place located beyond the encounter position in step S606 (No in step S606), or when, in step S608, the moving device 12 cannot reach the waiting place located beyond the encounter position before encountering the person (No in step S608), the control unit 21 determines whether there is a waiting place preceding the encounter position, that is, a waiting place located closer to the current position of the moving device 12 than the encounter position is in step S612. The control unit 21 searches for the waiting place based on the layout information. When such a waiting place is located (Yes in step S612), the control unit 21 proceeds to step S614. When such a waiting place is not located (No in step S612), the control unit 21 proceeds to step S616.

In step S614, the control unit 21 generates the waiting instruction for causing the moving device 12 to move to a waiting place preceding the encounter position and wait. For example, as shown in FIG. 7, when there is a waiting place 77 preceding the encounter position 75 along the route 72 of the moving device 12, the control unit 21 generates the waiting instruction for causing the moving device 12 to move to the waiting place 77 and wait at the waiting place 77. When there is a plurality of such waiting places, the control unit 21 selects the waiting place closest to the encounter position 75, that is, the waiting place closest to the delivery destination 71, and generates the waiting instruction. Thereby, the time for which the moving device 12 waits at the waiting place until the person passes the waiting place can be minimized, and eventually the moving device 12 can reach the delivery destination 71 in the shortest required time. Further, the control unit 21 derives the waiting time for which the moving device 12 is to wait at the waiting place 77 until the person passes the waiting place 77 based on the movement speed of the person, and includes information on the waiting time in the waiting instruction.

In step S616, the control unit 21 determines whether there is a detour route along which the moving device 12 reaches the delivery destination. The control unit 21 searches for the detour route based on the layout information. FIG. 7 shows a route 78 as an example of the detour route. The detour route 78 may be a route whose required time is expected to be longer than that of the initial route 72. When there is a detour route (Yes in step S616), the control unit 21 proceeds to step S618. When there is no detour route (No in step S616), the control unit 21 proceeds to step S620.

In step S618, the control unit 21 modifies the movement instruction generated in step S600 so as to cause the moving device 12 to move along the detour route.

When there is no waiting place or detour route, in step S620, the control unit 21 generates the waiting instruction for causing the moving device 12 to wait near the wall of the encounter position. For example, as shown in FIG. 7, the control unit 21 generates the waiting instruction for causing the moving device 12 to approach the wall and wait at the encounter position 75 along the route 72 of the moving device 12. Further, the control unit 21 derives the waiting time for which the moving device 12 is to wait near the wall until the person passes the encounter position based on the movement speed of the person, and includes information on the waiting time in the waiting instruction. Even when there is no suitable waiting place, it is possible to reduce the degree of interference between the moving device 12 and the person.

As a modification of the above, in step S602 of FIG. 6, the control unit 21 may detect a sign that the person in the room starts to move from the operating state of the electric equipment or the home appliance in the room, or the opening/closing states of the windows, curtains or doors of the room. For example, when the operation of electrical equipment or home appliances is stopped or suspended, when the windows or curtains that were open in the room are closed, or when the doors are opened or closed, there is a high probability that the person will go out. By performing machine learning for the movement history of the person after the operating state of such electrical equipment or home appliances, or the opening/closing states of windows, curtains, or doors, the control unit 21 can detect, from these events, the sign that the person in the room starts to move. Thereby, the control unit 21 can predict the encounter position earlier. For example, in FIG. 7, by detecting the sign of movement before the person in the room 73 starts to move along the route 74, the control unit 21 of the server device 11 predicts an encounter position 75a located closer to the delivery destination 71 than the encounter position 75 is. In that case, the control unit 21 sends the waiting instruction for causing the moving device 12 to wait at a waiting place 79 closest to the encounter position 75a. The control unit 21 can start the movement of the moving device 12 at an earlier timing than a case where the control unit 21 predicts the encounter position 75 after the person starts to move in the passage 7. Alternatively, when there is no waiting place near the encounter position 75a, that is, when the result is No in step S606, the result is No in step S612, and the result is Yes in step S616, the detour to the detour route 78 can be selected earlier in step S618. According to such a modification, the moving device 12 can start to move at an earlier timing, so that the moving device 12 can reach the delivery destination 71 earlier.

The positional relationship between the delivery destination 71 and the room 73 shown in FIG. 7 may be set as appropriate, and the room 73 may be located farther than the delivery destination 71 when the moving device 12 is used as a reference.

In the above, the case of predicting the encounter position with one person has been described as an example, but the present embodiment can also be applied to a case of predicting the encounter position with two or more persons. When the control unit 21 of the server device 11 acquires the movement information of two or more persons from the sensors of the collective facility 13, the control unit 21 predicts the encounter position with each person along the route of the moving device 12, and selects the waiting place in order from the closest encounter position predicted among the encounter positions to generate the waiting instruction. In this case, the control unit 21 predicts the positions of the moving device 12 and the person located after the lapse of the waiting time for each encounter position, and predicts the next encounter position. Further, in FIG. 7, an example of a flat layout on one floor is shown, but the route along which the moving device 12 and the person move may include a route along which the moving device 12 and the person move between floors by an elevator, an escalator, a staircase, or the like. In this case, the control unit 21 can predict the encounter position, derive the waiting place, etc. by an algorithm that takes the waiting time for the elevator and the like into account in advance.

Further, the delivery support system of the present embodiment can be applied not only to a case where the goods are products but also to a case where various relief goods, relief supplies and the like are delivered to the delivery destination in the collective facility 13. Further, the present embodiment can be applied even when the moving device 12 patrols, cleans, or the like in the collective facility 13 by a predetermined route without delivering the goods.

According to the embodiment described above, it is possible to accurately control the operation of the moving device 12 that delivers the goods to the delivery destination in the collective facility 13.

In the embodiment described, the processing/control program defining the operation of the control device 30 may be stored in the server device 11, and downloaded to each device via the network 14. Alternatively, the processing/control program may be stored in a portable, non-transitory recording/storage medium that can be read by each device, and may be read from the medium by each device.

The present disclosure is not limited to the embodiment described above. For example, blocks shown in the block diagram may be integrated, or a block may be divided. Instead of executing the steps shown in the flowcharts in chronological order according to the description, the steps may be executed in parallel or in a different order, depending on the processing capacities of the devices that execute the steps, or as necessary. Other changes may be made without departing from the scope of the present disclosure.

What is claimed is:

1. A server device comprising:
a communication unit; and
a control unit that sends and receives information to and from another device via the communication unit, wherein the control unit generates, based on information on a route along which a moving device is to move in a collective facility and information indicating movement of a person in the collective facility, a waiting instruction for causing the moving device to wait at a waiting place near an encounter position where the moving device encounters the person on the route until the person passes the waiting place, and sends the waiting instruction to the moving device.

2. The server device according to claim 1, wherein the control unit selects the waiting place closest to a destination on the route and generates the waiting instruction.

3. The server device according to claim 2, wherein when the control unit selects the waiting place located closer to the destination than the encounter position is, the control unit sends, to the moving device, a first instruction for changing a movement speed of the moving device.

4. The server device according to claim 1, wherein the information indicating the movement of the person is acquired from a sensor provided in the collective facility and includes information indicating a sign of the movement of the person.

5. The server device according to claim 4, wherein the control unit sends the waiting instruction to the moving device before the person starts to move, based on the information indicating the sign of the movement of the person.

6. The server device according to claim 1, wherein the control unit has information indicating a shape, a dimension, or an arrangement of a passage in the collective facility, and generates the waiting instruction based on the information indicating the shape, the dimension, or the arrangement of the passage.

7. The server device according to claim 1, wherein the control unit sends, to the moving device, a second instruction for causing the moving device to move along another route on which the moving device does not encounter the person.

8. A system having the server device and the moving device according to claim 1.

9. A control device mounted on a moving device and having a communication unit and a control unit for sending and receiving information to and from another device via the communication unit, wherein:
a server device generates, based on information on a route along which the moving device is to move in a collective facility and information indicating movement of a person in the collective facility, a waiting instruction for causing the moving device to wait at a waiting place near an encounter position where the moving device encounters the person on the route until the person passes the waiting place; and
when the control unit receives the waiting instruction from the server device, the control unit controls the moving device according to the waiting instruction.

10. The control device according to claim 9, wherein the control unit controls the moving device based on the waiting instruction generated by selecting the waiting place closest to a destination on the route.

11. The control device according to claim 10, wherein in a case where the server device sends a first instruction for changing a movement speed of the moving device when the waiting place located closer to the destination than the encounter position is, is selected, the control unit controls the moving device according to the first instruction.

12. The control device according to claim 9, wherein when the server device acquires the information indicating the movement of the person from a sensor provided in the collective facility and the information includes information indicating a sign of the movement of the person, the control unit causes the moving device to start to move according to the waiting instruction before the person starts to move.

13. The control device according to claim 9, wherein when the control unit receives a second instruction, from the server device, for causing the moving device to move along another route on which the moving device does not encounter the person, the control unit controls the moving device according to the second instruction.

14. The moving device equipped with the control device according to claim 9.

15. An operation method of a system having a server device and a moving device that perform information communication with each other, wherein:
the server device generates, based on information on a route along which the moving device is to move in a collective facility and information indicating movement of a person in the collective facility, a waiting instruction for causing the moving device to wait at a waiting place near an encounter position where the moving device encounters the person on the route until the person passes the waiting place, and sends the waiting instruction to the moving device; and
the moving device operates according to the waiting instruction.

16. The operation method according to claim 15, wherein the server device selects the waiting place closest to a destination on the route and generates the waiting instruction.

17. The operation method according to claim 16, wherein when the server device selects the waiting place located closer to the destination than the encounter position is, the server device sends, to the moving device, a first instruction for changing a movement speed of the moving device.

18. The operation method according to claim 15, wherein the server device has information indicating a shape, a dimension, or an arrangement of a passage in the collective facility, and generates the waiting instruction based on the information indicating the shape, the dimension, or the arrangement of the passage.

19. The operation method according to claim 15, wherein:
the information indicating the movement of the person is acquired from a sensor provided in the collective facility and includes information indicating a sign of the movement of the person; and
the server device sends the waiting instruction to the moving device before the person starts to move, based on the information indicating the sign of the movement of the person.

20. The operation method according to claim 15, wherein the server device sends, to the moving device, a second instruction for causing the moving device to move along another route on which the moving device does not encounter the person.
